(19) United States
(12) Patent Application Publication
(10) Pub. No.: US 2001/0033654 A1
(43) Pub. Date: Oct. 25, 2001

(54) W-EC1 encryption and decryption method and system

(76) Inventor: Gabor Wieser, Plano, TX (US)

Correspondence Address: W. Thomas Timmons, The White House on Turtle Creek, 2401 Turtle Creek Boulevard, Dallas, TX, 75219-4760, US

(21) Appl. No.: 09/760,262

(22) Filed: Jan. 12, 2001

Related U.S. Application Data
(60) Provisional application No. 60/176,176, filed on Jan. 13, 2000.

(51) Int. Cl. H04K 1/00

(52) U.S. Cl. 380/28

(57) ABSTRACT

The present invention provides an encryption and decryption method and system to encipher and decipher binary data. The operation of the system is controlled by parameter values. The data to be encrypted is divided into blocks of tokens. Multiple copies of these blocks are created. In each token bits are moved into the lowest order bits according to a pattern. The highest order bits are replaced by pseudo-random bits. A series of modulo additions and rotations are performed and then a substitution operation and a transposition operation are performed producing the final cipher text. The decryption method is the reversal of the encryption method.

### BACKGROUND OF THE INVENTION

1. Field of the Invention

The present invention relates to the art of cryptography. More specifically it is a method and system for private key encryption of binary data, such as used in data processing environments and telecommunications.

2. Description of Related Art

The need for confidential storage and communication of data was recognized early in history. Many systems were invented and refined in the history of cryptography. The majority of these systems were private key systems, relying on two parties having identical keys and a common method to encipher and decipher the data. In spite of the invention of public key systems, private key systems are still used in the majority of time by the virtue of their greater speed and security.

The problem of security and privacy is a greater and greater concern in the data processing industry. Since the middle of the seventies cryptographic devices and methods are widely available. IBM developed and patented some early systems (U.S. Pat. Nos. 3,798,359, 3,798,360, 3,962,539, 3,958,081). In 1977 the National Bureau of Standards adopted the Data Encryption Standard, largely based on IBM's proposals. Since then there were numerous enhancements and variations of this system. There are also a number of other encryption systems on the market, like IDEA, Blowfish, RC5 etc. At the same time the cryptanalysis has developed at an equally great pace, so that, for example, the original DES is no longer thought to be secure.

Another direction of the industry was the development of less secure but faster methods, since the high security encryption systems typically require complex multi-round manipulation of data. A recent example of this type is U.S. Pat. No. 5,548,648, which is a faster, but less secure method than DES.

Further general description of cryptographic systems and their use can be found in “ICSA Guide to Cryptography” by Randall K. Nichols (McGraw-Hill, 1999).

### SUMMARY OF THE INVENTION

Therefore, in spite of all the prior advances in the field, there is still a need for a highly secure and fast method and system for privacy and security.

Accordingly the present invention provides a method and system to encrypt binary digital data in a fast and highly secure manner, and also a corresponding fast decryption method and system. This method and system can be implemented in software, hardware or firmware.

The present invention comprises a system of parameters, a method of eight steps to achieve the above stated goal for encryption of data, and a method of seven steps to decrypt the cipher text.

In the first step of the encryption method an input block of b tokens of t bits (binary digits) is taken from the data to be encrypted, padded to b tokens, if necessary. This block is duplicated. In the second copy the upper t/2 bits are moved to replace the lower t/2 bits. (See the detail description and the section below about parameter choices regarding handling special cases like odd t, more than two copies and different patterns of moving the significant bits.) The concatenation of all copies starting with the first copy will be referred to as the complete block in further discussions.

In the second step tokens are considered as binary numbers. Their location is added to their value modulo 2^{t}.

In the third step the upper half of all tokens in the complete block are replaced by pseudo-random bits.

In the fourth step the bits with a value of one are counted in each 2^{t/2} token segment. These counts are changed by exclusive ORing some of their bits. Then the changed counts are rotated left by 1 bit and the lowest order bits are made equal to the complement of the next lowest order bits. The resulting numbers are used as the counts of bits the segments are rotated by.

In the fifth step tokens are considered as binary numbers. Their location is added to their value modulo 2^{t}.

In the sixth step the bits with a value of one are counted in the complete block. This count is changed by exclusive ORing some of its bits and rotating it left. The resulting number is used as the count of bits the complete block is rotated by.

In the seventh step a private key consisting of 2^{t} tokens is used in a token by token substitution. This key is a permutation of all possible tokens.

In the eighth step a second private key consisting of cb tokens is used in a token by token transposition. The resulting block is the cipher text.

In the first step of the decryption method the eighth step of the encryption is reversed by using the reverse of the key originally used.

In the second step the substitution is similarly reversed by applying the reverse key of the original key.

In the third step the same count is derived as in encryption step six. The whole block is rotated by this number of bits in the opposite direction than during encryption. The value of the count is reproducible, because the rotation does not change the number of bits with the value of one.

In the fourth step we subtract the locations of the tokens from their value modulo 2^{t}.

In the fifth step the same counts are derived as in encryption step four. Each segment is rotated by the number of bits of these counts in the opposite direction than during encryption. The values of these counts are also reproducible as in decryption step three.

In the sixth step we subtract the locations of the tokens from their value modulo 2^{t}.

In the last step the two half blocks are merged to regain the plain text by moving the lower half tokens of the second half to the upper half tokens of the first half.

### Parameters for the System

Some values for this system can be chosen during implementation or even changed between the encryption of different blocks. These can be considered as parameters for the system. Good examples are the rotational directions during encryption. These can be set for an implementation, chosen together with the keys, or a system can be devised to change it, for example after a predetermined number of blocks or at certain times, like every hour.

The token length or the number of copies made during the first step are other examples of parameters. FIG. 1 has a list of these parameters and recommendations for them.

Care must be used in choosing the parameter values, because improper choices can have a detrimental effect on the speed or the security of the system. Important considerations are mentioned in the detailed description.

Recommended values are used throughout the detailed description and in the figures. These values will result in a fast encryption and a very high level of security. Other choices and their interdependencies are discussed at the appropriate places.

These and other objects, advantages and features of this invention will be apparent from the following description taken with reference to the accompanying drawing, wherein is shown a preferred embodiment of the invention.

### BRIEF DESCRIPTION OF THE DRAWING

FIG. 1 is a table of some parameters and recommended values according to the present invention;

FIG. 2 is a pictorial representation of creating a duplicate block and shifting the upper half bytes into the lower ones according to the present invention;

FIG. 3 is a table of effective values added to the lower half tokens;

FIG. 4 is a pictorial representation of the contents of a token after Step 3;

FIG. 5 is a pictorial representation of the changes to the value of Sₗ;

FIG. 6 is a pictorial representation of rotations of the segments;

FIG. 7 is a pictorial representation of the changes to the value of S_{T};

FIG. 8 is a pictorial representation of the complete block with right rotation;

FIG. 9 is a pictorial representation of a token substitution;

FIG. 10 is a pictorial representation of moving a token during transposition;

FIG. 11 is a pictorial representation of the relationship between the transposition key and its reverse key; and

FIG. 12 is a pictorial representation of the relationship between the substitution key and its reverse key.

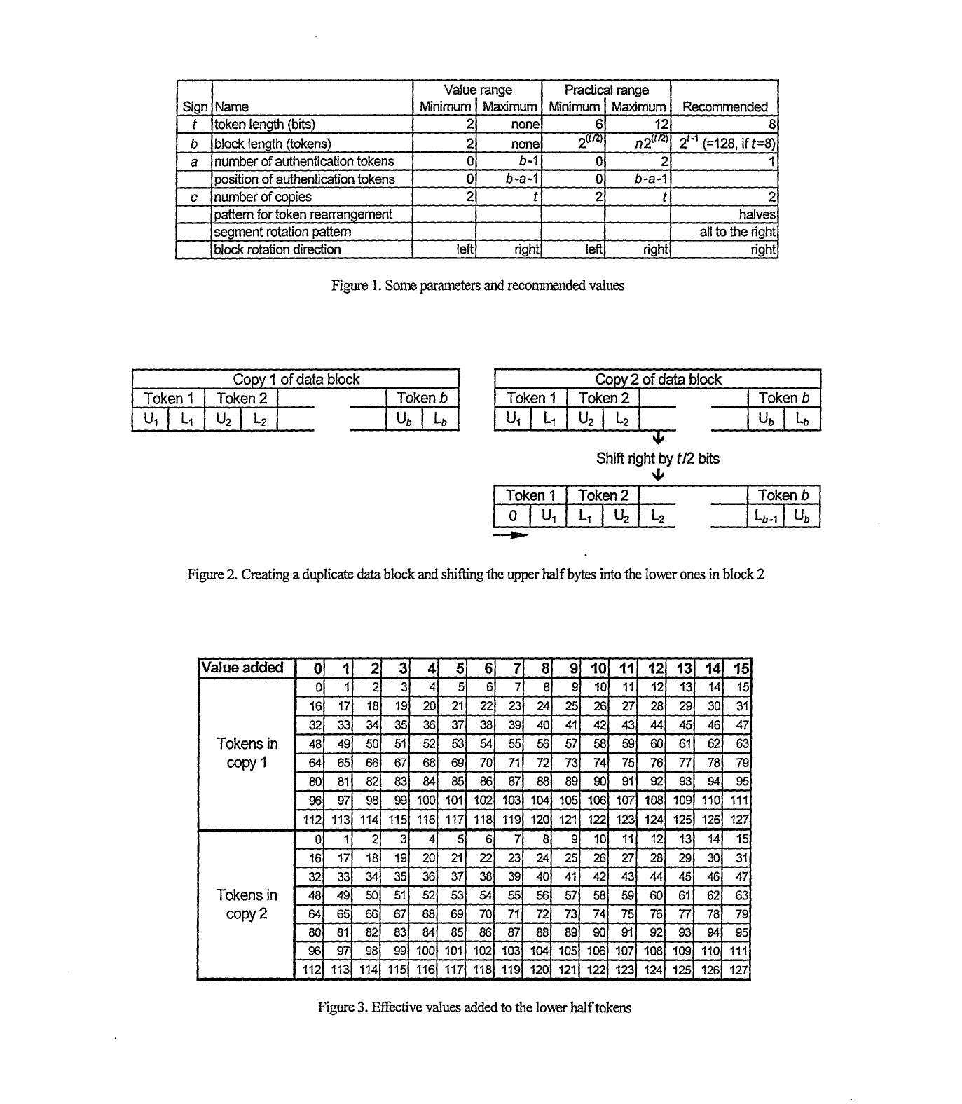

### DESCRIPTION OF THE PREFERRED EMBODIMENT

The object of this system is to transform a continuous or finite length bit stream (clear text input) into an encrypted bit stream, which is resistant to cryptanalysis.

The clear text input is considered to consist of blocks of b tokens of t bits (binary digits). If the last block is fewer than b tokens, then it is padded with binary zeros to b token length. The data can be computer originated data, or video, audio, telemetry or any other kind of information, which can be encoded in binary format, as it is a widespread practice today.

The value of t (token length) can be chosen for a particular implementation to be an integer of 2 or greater. However, since the choice of t will determine the size of key space for the substitution key (see discussion below), the practical minimum value is six and anything larger than twelve will lead to very large keys. A very good choice is eight. This gives a good balance of security and key size, and also coincides with the usual byte size in the computer industry.

The value of b (block length) can also be chosen for a particular implementation to be an integer of 2 or greater. Again, practical considerations apply: a value too small will weaken the method, while a value too large will make it cumbersome. A good practical value is 2^{t-1} (possibly an n integer multiple of it). If eight were chosen for t then this would make b=128.

If authentication is desired for each block, then b-a tokens can be taken from the input stream and a authentication tokens can be generated, for example by summing all the tokens modulo 2^{at}. These authentication (hash) tokens can be inserted into the block of b-a tokens at any point, together or separately, giving further parameters to the system. The use of the authentication tokens should not have a practical effect on the strength of the system. In further discussions we will refer to b data bytes regardless if it includes authentication tokens or not.

After the b tokens comprising a block are segregated, perhaps in a buffer (in case of a hardware implementation) or in a work area (software implementation), c copies of it are made. The value of c is another parameter to the system. The value range is between 2 and t. The length of the generated cipher text will be cb, thus the choice has a significant effect on the size of the cipher text. c=2 gives sufficient security; choosing a higher number is likely an unnecessary complication of the system without achieving significant gains in encryption strength. A better way to increase security is to increase the token length.

In the second copy of the block the upper t/2 bits are moved into the lower t/2 bits in every token. (FIG. 2) A simple way to accomplish this is to shift the whole second copy of the buffer right by t/2 bits.

Instead of moving the upper halves in the second copy another pattern can be also chosen to move data into the lowest bits of the tokens. This is necessary if c is greater than 2. For example, let c be 4 and t 8. In the first block the leftmost two bits are moved to the lowest two bits, in the second copy bits 5 and 6 are moved to the lowest bits, in the third copy the lowest two bits are left in place, and in the fourth copy bits 3 and 4 are moved to the lowest two bits. Thus the lowest two bits of all copies combined contain all the bits of the original clear text. Similarly if t is odd α decision has to be made how to divide the bits. Again, there are many different ways of accomplishing the goal of moving all the clear text bits into the lower bits of the copies, but c=2 and a single shift operation to move the halves in the second block is likely the optimum implementation of the system. In further discussions it will be assumed that those choices were made.

In the second step the location of each token (as a binary number) is added to the value of the token (as a binary number) modulo 2^{t}. Thus zero will be added modulo 2^{t} to the value of the first token, 1 to the second, etc. Modulo 2^{t} addition in the binary system simply means that the carry is discarded, so it is very fast either in software or hardware implementations. The purpose of this step is to smooth out the frequency distribution of the lower half tokens. (FIG. 3 shows the effective change to the lower half tokens. The upper half tokens will be replaced later.) Let

p₁, p₂, p₃, . . . , pₗ

be the frequency distribution for the 2^{t/2} possible lower half tokens. The result of the addition in the lower half token will be

(ν+l) mod (2^{t/2})

where ν is the original value of the lower half token and l is the location. There are 2^{t/2} possible results. If the value of a token is independent of its location (that is a half token with value ν occurs with equal probability in position l=0 mod (2^{t/2}), as it does in position 1 mod (2^{t/2}), and 2 mod (2^{t/2}), etc.), then the probability of adding l to a token is 1/(2^{t/2}), and the probability of getting a ν′ result from ν is

q_{(ν, ν′)}=p_{ν}/2^{t/2}

Since the probability of all possible ν′ results are the same for p_{ν}, the frequency of the lower half token results will be equally distributed after the addition for every ν.

The total probability of getting a ν′ value from any token is the sum of the probability of q_{(ν, ν′)} for all ν values

q_{ν′}=q_{(0, ν′)}+q_{(1, ν′)}+ . . .

which can be written as

q_{ν′}=(p₀/2^{t/2})+(p₁/2^{t/2})+ . . .

Since this probability is the same for all ν′, the frequency distribution will be smooth.

This smooth distribution will only work with appropriate b values. The ideal b value is 2^{t-1}, but any n multiple of 2^{t/2} is acceptable.

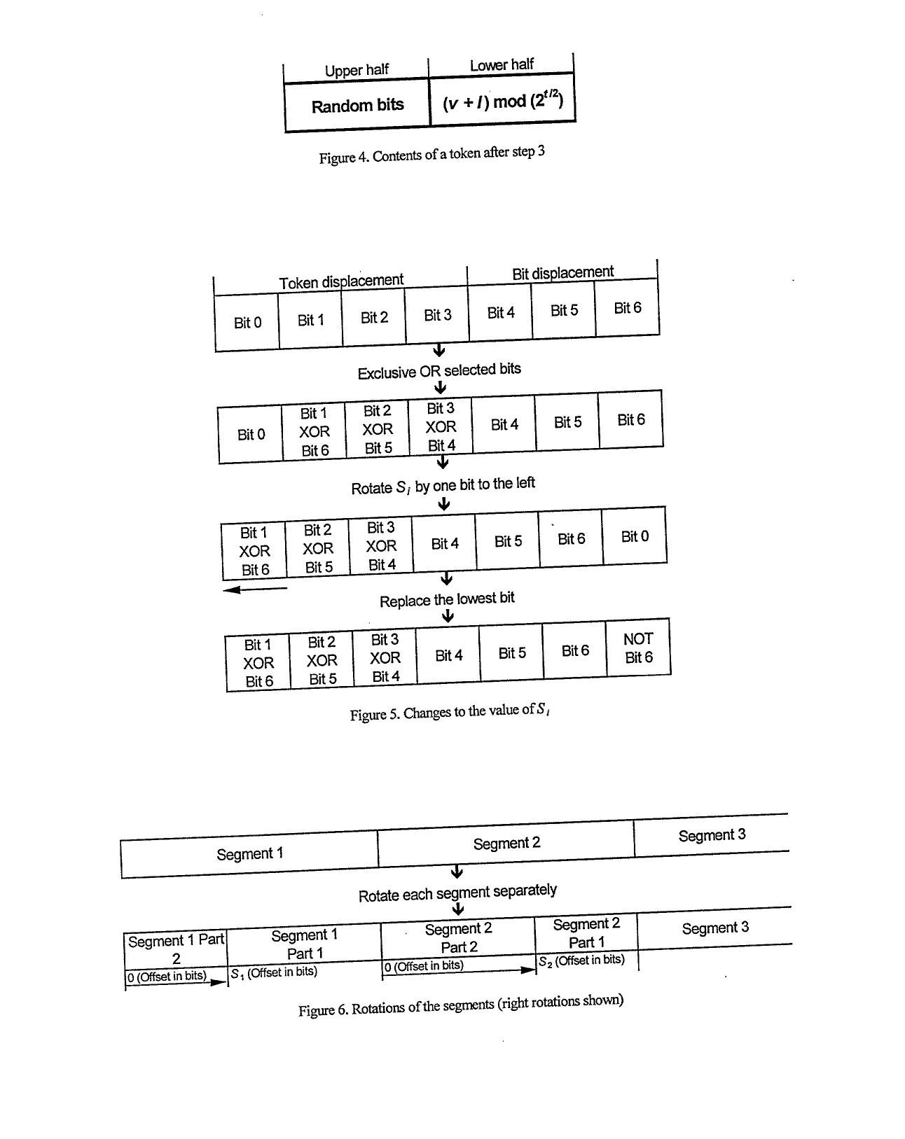

In the third step pseudo-random bits replace the upper half tokens in the complete block. A pseudo-random bit string of the length of at least (c−1)bt should be available for the system for this purpose per block. We will assume that the system has access to a continuous stream of pseudo-random bits. Perfect randomness is not required. The level provided by most available pseudo-random number generators (hardware or software) will suffice. FIG. 4 depicts the contents of a token after this step.

The purpose of this step is twofold: first is to introduce a false frequency distribution to the previously smoothed data, and secondly to generate different encoding for the same clear text, and thus defeat traffic analysis. If t=8, b=128, and c=2 the same data block could be changed into 2¹⁰²⁴ (>10³⁰⁸) different derivative blocks.

In the fourth step the complete block is considered to consist of segments of 2^{t/2} tokens. A count Sₗ will be taken in each segment of all the bits with a value of one. (Bits with the value of zero can be used equally well as long as the choice is consistent. In the following, one is used as an example, but a separate choice can be made for each count as to which bits to count up.) These Sₗ counts, after further manipulation, will be used as the number of bits that their segment will be rotated by. If t is an exponent of two then Sₗ can be segregated into two parts: the lowest part equals to the displacement of bits within a token, the higher part is the displacement of tokens within the 2^{t/2} token length segment in tokens. In case of the recommended values the lowest three bits of Sₗ are the displacement within the tokens and the highest four bits are the displacement of tokens within 16 token segments. Since the probability of the second class of rotation is not evenly distributed, the following correction is made to the value of each Sₗ: the lowest bit of the bit displacement is exclusive ORed into the second highest bit of the token rotation displacement, the second lowest bit of the bit displacement is exclusive ORed into the third highest bit of the token rotation displacement, etc. The count is then rotated by one bit to the left. (FIG. 5) In these changed Sₗ counts the lowest bit is then replaced by the complement (Boolean NOT) of the second lowest bit to ensure that bit displacements are the most effective. Then each segment is rotated by its corresponding modified Sₗ bit positions. (FIG. 6) The direction of rotation for each segment can be independently implementation defined or can change according to some predefined pattern, for example depending on time or number of blocks.

The purpose of this step is to destroy location dependency and token alignment patterns. The token alignment destruction is assured by allowing only the 01 and 10 combinations for the last two bits for the rotation counts. These values provide the most effective alignment for the tokens for the next step. This step also magnifies the effects of a single bit change. The single bit change changes the rotational value and the results of this step. The further steps magnify this change to the point that the two cipher texts will have little commonality at the end.

In the fifth step the location of each token (as a binary number) is added to the value of the token (as a binary number) modulo 2^{t}. Thus zero will be added modulo 2^{t} to the value of the first token, 1 to the second, etc. Modulo 2^{t} addition in the binary system simply means that the carry is discarded, so it is very fast either in software or hardware implementations. This step is the same procedure as step two. The purpose of this step is to distribute the frequency, if step two would have produced lower half tokens with all the same value. (A possibility if a cryptanalyst is able to send arbitrary data through the system. For example the hex byte stream of 00, FF, EE, . . . , 11 results in all zero lower half tokens.) After step four these identical t/2 bit strings will be placed at the same location in every token within a segment. The addition of the location modulo 2^{t} will smooth out the frequency, like in step 2. The possible carry from the lower bits will provide added randomness to the result. This round of additions cannot be anticipated, because of the rotation in step four, which depends on the number of bits with a value of one contained in the pseudo-random bitstream.

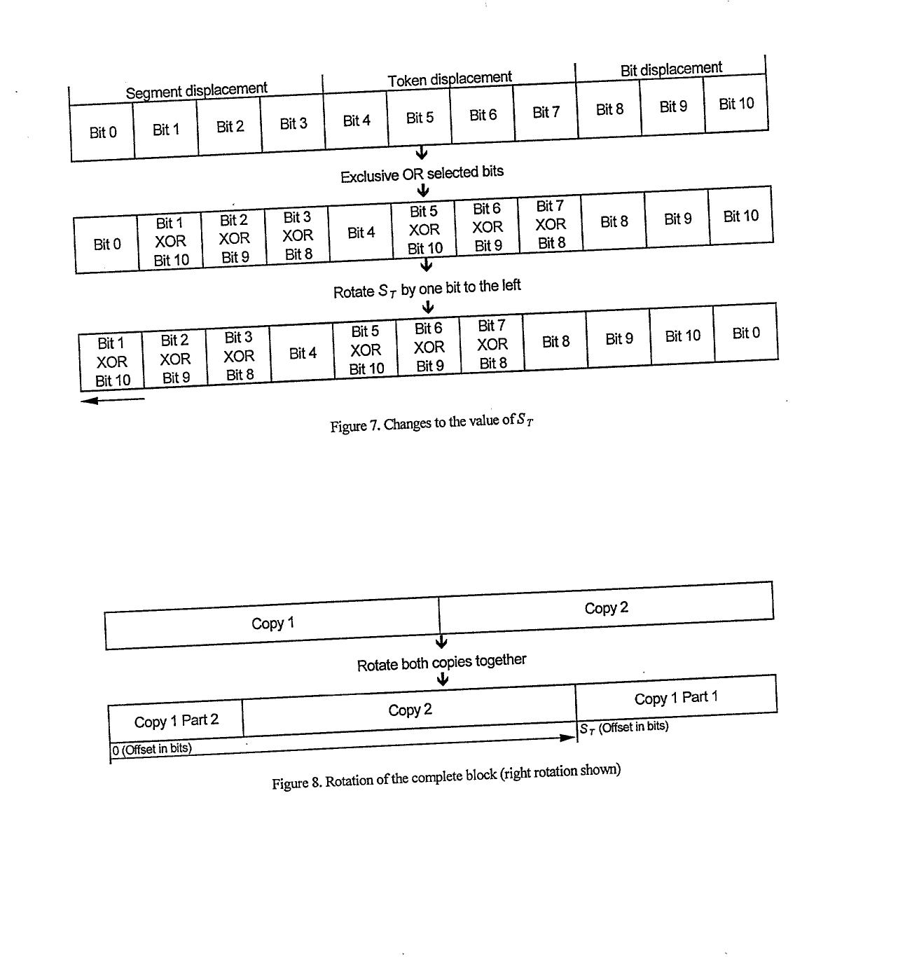

In the sixth step a count S_{T} will be taken in the complete block of all the bits with a value of one. S_{T} after further manipulation will be used as the number of bits the complete block will be rotated by. If t and b are exponents of two then S_{T} can be segregated into three parts: the lowest part equals to the displacement of bits within a token in bits, the middle part is the displacement of tokens within the 2^{t/2} token length segment in tokens, and the third part is the displacement of the segments within the complete block by number of segments. In case of the recommended values the lowest three bits of S_{T} are the displacement within the tokens, the next lowest four bits are the displacement of tokens within 16 token segments, and the upper four bits are the displacement of the 16 token segments. Since the probability of the second two classes of rotation are not evenly distributed, the following correction is made to the value of S_{T}: the lowest bit of the bit displacement is exclusive ORed into the second highest bit of both the segment and token rotation displacement, the second lowest bit of the bit displacement is exclusive ORed into the third highest bit of both the segment and the token rotation displacement, etc. The count is then rotated by one bit to the left. (FIG. 7) Then the complete block is rotated as a unit by the modified S_{T} bit positions. (FIG. 8) The direction of rotation can be implementation defined or can change according to some predefined pattern, for example depending on time or number of blocks.

The purpose of this step is to destroy location dependency and token alignment patterns possibly introduced by the second addition of location. This step also magnifies the effects of a single bit change.

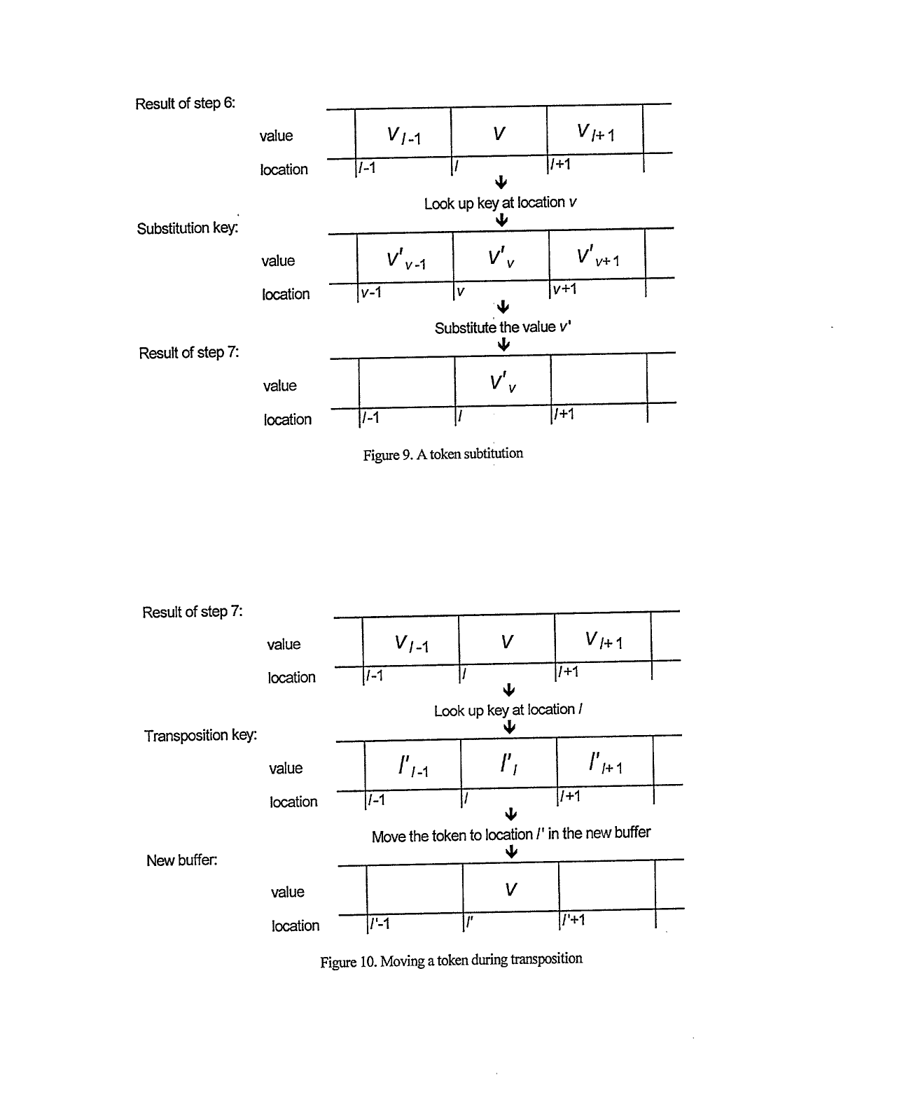

The seventh step is a substitution transformation done according to a private key. The key is a permutation of all 2^{t} possible tokens. This makes the substitution reversible. Keys where location of a token is equal to its value are considered to be weak keys and should not be used. It is easy to see that the number of non-weak keys is more than (2^{t}−1)! In case of t=8 that is more than 255! (>10⁵⁰⁴). The substitution is done on a token by token basis for the complete block. For a token having a value ν in the result of the previous step a value of ν′, the value found in the key at location ν is substituted. (FIG. 9)

The eighth step is a transposition transformation done according to a second private key. The key is a permutation of all cb possible location values of the concatenated copies of the data blocks. This is also a reversible key. Omitting weak keys again (the same considerations apply as in step seven), the number of possible keys is more than (cb−1)! If c=2 and b=128, then this is the same number as in before, giving the total key space of more than 10¹⁰⁰⁹. The transposition is done on a token by token basis, building a new buffer or workarea with the transposed values, so the original tokens are not destroyed in the process. A token at location l in the result of step seven is moved into a location l′ in the new buffer (the result of step eight). l′ is found in the key at location 1. (FIG. 10)

The new block is the cipher text. It is resistant to analysis based on frequency of distribution or location dependencies. It is also resistant of traffic analysis as long as blocks are transmitted at an even pace. When there is no data to be transmitted blocks of binary zeros can be used, since the probability of two of these blocks being encrypted the same way is extremely low. The keys cannot be reconstructed even with the knowledge of a large number of arbitrary blocks in both clear and cipher form.

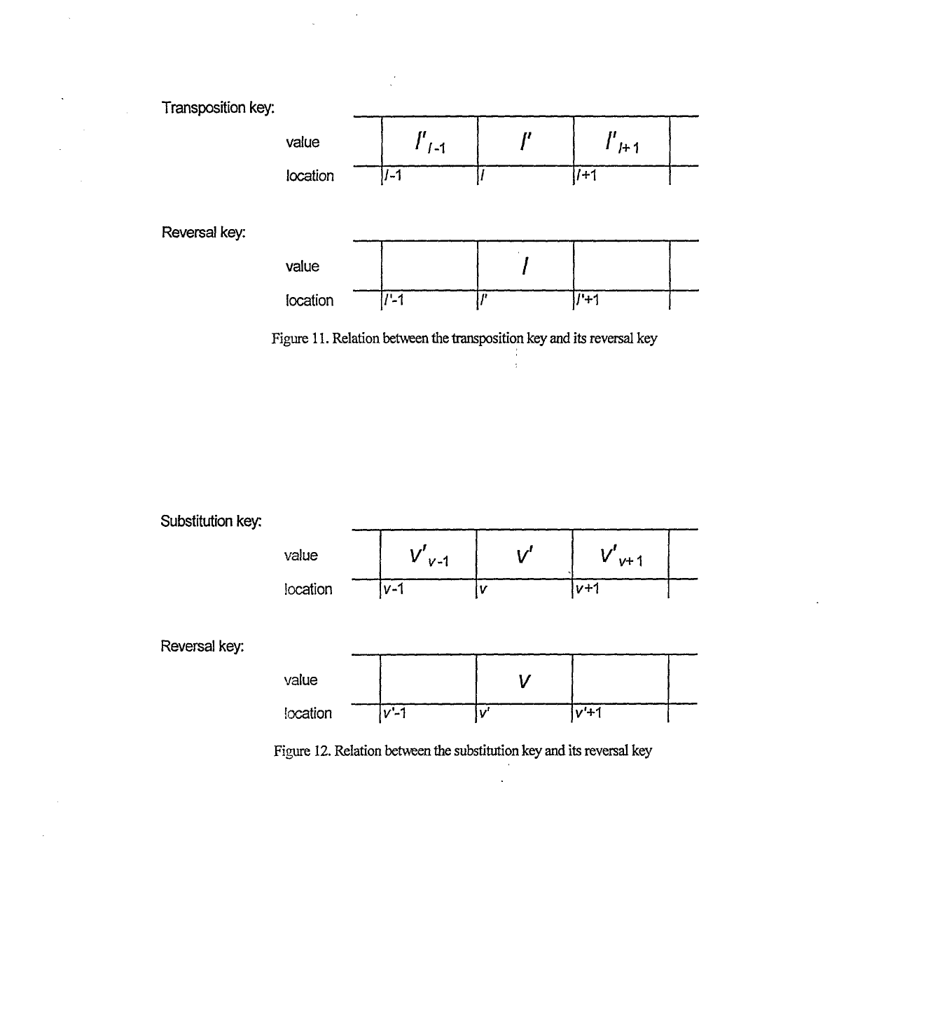

The first step of the decryption is the reversal of the transposition in step eight of the encryption. The process is exactly the same as in that step with the exception that the reversal of the original key is being used. The reversal key is built from the original the following way: if the original key has at location l the value of l′, then the reversal key will have the value of l at location l′. (FIG. 11)

The second step of decryption reverses the substitution in the seventh step of the encryption. The process is again the same as in the encryption step with the reversal of the substitution key used. The reversal key is built from the original the following way: if the original key has at location ν the value of ν′, then the reversal key will have the value of ν at location ν′. (FIG. 12)

The third step of decryption reverses the rotation in the sixth step of the encryption. First the S_{T} count of that step is recalculated by using the same method. Since the rotation does not change the number of the bits with a value of one, the starting count for S_{T} will be the same as in the encryption step. The same exclusive ORs and rotation are again performed on S_{T}, resulting in the same final value for the count as in the encryption step. Using this value the complete block is rotated to the opposite direction as during encryption.

The fourth step of decryption reverses the modulo addition of the fifth step of encryption. The location of each bit is subtracted from its value and the result modulo 2^{t} becomes the new value of the token. In most implementations this can be done by performing the subtraction and disregarding the borrow.

The fifth step of decryption reverses the rotation in the fourth step of the encryption. First the Sₗ counts of that step are recalculated by using the same method. Since the third step of decryption has restored the segments to their original place and the rotation within the segment does not change the number of the bits with a value of one, the starting values for the Sₗ counts will be the same as in the encryption step. The same exclusive ORs and rotation are again performed on each Sₗ, including the replacement of the lowest bit. The results will be the same final values for each count as in the encryption step. Using these values the segments are rotated to the opposite direction as during encryption.

The sixth step of decryption reverses the modulo addition of the second step of encryption. The location of each bit is subtracted from its value and the result modulo 2^{t} becomes the new value of the token. In most implementations this can be done by performing the subtraction and disregarding the borrow.

In the seventh step of decryption the half tokens are merged back again to regain the original clear text. (If another pattern of bit moves was used than the half token, then a reversal of that process has to be used.) Each lower half token of the second copy has to be moved into the upper half of the corresponding token in the first copy. For some implementations an efficient way to achieve this is to first shift the second copy left by t/2 bits, zero out the lower half tokens (a Boolean AND operation can be used for the purpose), zero out the upper half tokens in the first copy, and then perform a Boolean OR operation of the two strings.

Both the encryption and decryption methods use simple bit oriented operations only, with no lengthy iterations involved. This makes the method and system very fast, applicable in most data transfer and data storage applications. It is easy to implement in hardware, software, or firmware.

1. A method for encrypting binary data comprising of blocks of tokens, which in turn are comprised of bits, into a binary cipher, comprising the steps of:
segregating a block of binary data from the input stream, making multiple copies of it, and moving the significant digits into the lower bits of the tokens according to a predefined pattern;
modifying the said significant digits by adding their location to their values;
replacing the other (non-significant) binary digits by pseudo-random bits;
rotating segments, which are groups of tokens, of the resulting block by values derived from the count of the bits with a predetermined value of one or zero in the said segments;
modifying the tokens by adding their locations to their values;
rotating the resulting block by a value derived from the count of the bits with a predetermined value of one or zero in the block;
performing a token by token substitution transformation on the block by using a private key, which is a permutation of all possible tokens;
performing a token by token transposition transformation on the block, using a private key, which is the permutation of all possible locations.

2. The system and method as defined in claim 1 wherein the segregation of the blocks is done under the control of two parameters, the t token length (number of bits in a token) and the b block length (number of tokens in a block).

3. The system and method as defined in claim 2 further comprising the step of inserting one or more authentication tokens into the data at any desired location.

4. The system and method as defined in claim 3 further comprising the step of making a plurality of copies of the data according to parameter c (the number of copies), and thus generating a complete block.

5. The method as defined in claim 4 further comprising a method to change the frequency distribution of the tokens in the said complete block by the following steps:
moving the significant bits of each token to the lowest bits according to a pattern for each copy of the data;
summing the location as a binary number and value as a binary number modulo 2^{t} for each token and changing the value of the token to this result;
filling the non-significant bits of the tokens with pseudo-random bits;
generating an Sₗ rotation amount for each segment and rotating it;
summing the location as a binary number and value as a binary number modulo 2^{t} for each token again;
generating an S_{T} rotation amount for the complete block and rotating it.

6. The method as defined in claim 5 wherein the pattern for moving the significant bits is a further parameter of the system. This pattern defines which bits are significant in each copy. All combinations work, which satisfy the following criteria: every block has to have at least two significant bits and each source bit has to be represented at least in one copy as significant.

7. The method as defined in claim 5 further comprising a method to generate a count for segment rotation (Sₗ) by the following steps:
XORing the bits of the bit displacement value into the token displacement value in reverse order;
rotating the count by one bit to the left;
replacing the lowest order bit by the complement of the second lowest order bit.

8. The method as defined in claim 5 further comprising a method to generate a count for complete block rotation (S_{T}) by the following steps:
XORing the bits of the bit displacement value into the token displacement and segment displacement values in reverse order;
rotating the count by one bit to the left.

9. The system and method as defined in claim 1 further comprising a method to encrypt the data by the following steps in any sequence:
performing a token by token substitution transformation on the modified block by using a private key, which is a permutation of all possible tokens;
performing a token by token transposition transformation on the block resulting from the substitution, using a private key, which is the permutation of all possible locations.

10. The method to mask token frequencies comprising the steps of:
distributing the bits of a token among a plurality of tokens;
moving these bits to the lowest order bits of the tokens;
replacing the other bits with pseudo-random bits;
summing the location as a binary number and value as a binary number modulo 2^{t} for each token.

11. The method to use the count of bits with a predetermined value of one or zero in a bit string as the rotational value for the string.

12. A method for decrypting binary data from a binary cipher, comprising the steps of:
performing a token by token transposition transformation on the block, using a private key, which is the reversal key of the encryption key;
performing a token by token substitution transformation on the block by using a private key, which is the reversal key of the encryption key;
rotating the resulting block by a value derived from the count of the bits with a value of one in the block;
modifying the tokens by subtracting their locations from their values;
rotating segments of the resulting block by values derived from the count of the bits with a value of one in the said segments;
modifying the tokens by subtracting their locations from their values;
merging the bits from all the copies according to the reversal pattern of the encryption pattern.
